(19) United States
(12) Patent Application Publication
(10) Pub. No.: US 2010/0161358 A1
(43) Pub. Date: Jun. 24, 2010

(54) SYSTEM AND METHOD FOR COMPARATIVE ANALYSIS OF TICKETS AND DISPATCHES

(75) Inventors: Venket Kandanala, Highland Village, TX (US); Fazil C. Ummer, Alappuzha (IN); Sivakumar Thrichangu, Vettrinagar (IN); Sudarshan Selvakumar, Irving, TX (US); Rajesh Narayanan, Nagar (IN); Jubish Cheriya Parambath, Saligrammam (IN)

Correspondence Address: VERIZON;PATENT MANAGEMENT GROUP, 1320 North Court House Road, 9th Floor, ARLINGTON, VA, 22201-2909, US

(73) Assignees: Verizon Data Services India Private Ltd., Guindy (IN); Verizon Data Services LLC, Temple Terrace, FL (US)

(21) Appl. No.: 12/338,019

(22) Filed: Dec. 18, 2008

(51) Int. Cl. G06Q 10/00

(52) U.S. Cl. 705/7

(57) ABSTRACT

A system and method for comparative analysis of tickets and/or dispatches including a receiver, at a baseline engine, configured to receive data associated with at least one of a product and a service corresponding to one or more tickets or dispatches, a processor, at the baseline engine, configured to generate baseline information based on the data, wherein the baseline information represents a comparative analysis of the at least one of a product and a service, and a transmitter, at the baseline engine, configured to transmit the baseline information to an output device for assessing the at least one product and service.

### BACKGROUND INFORMATION

Television, data, and voice services are popular among consumers. In fact, a single service provider may be capable of providing all of these services to its subscribers. However, subscribers of one or all of these services may have issues associated with these services which may require attention of the service provider. For every issue, a “ticket” may be generated by the service provider. Employees, representatives, and/or technicians of the service provider may respond to these tickets by transmitting “dispatches” to resolve issues associated with the ticket. In order to provide improved products/services, monitoring and analyzing tickets/dispatches may be important. For example, a service provider may receive a large number (e.g., approximately 500,000) of tickets/dispatches per month associated with its services, and many of the issues may be similar or may suggest a pattern or trend. By monitoring, analyzing, and/or categorizing the received/resolved tickets and/or dispatches, a service provider may be able to establish a standard, streamlined approach to not only provide resolution to these issues, but to also improve overall product operations and support. As a result, as advancements in technology and corresponding problems/issues continue to rise, current systems may lack a technique to comprehensively and effectively monitor and/or analyze root cause problems or patterns (e.g., in tickets and/or dispatches) that may be useful for improving future releases/updates and optimize standards for overall product delivery.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for comparative analysis of tickets and/or dispatches, according to an exemplary embodiment;

FIG. 2 depicts a block diagram of a baseline module/system architecture for comparative analysis of tickets and/or dispatches, according to an exemplary embodiment; and

FIG. 3 depicts a flowchart of a method for comparative analysis of tickets and/or dispatches, according to an exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for analyzing tickets. That is, exemplary embodiments may, among other things, expand and optimize analysis of tickets by comprehensively and effectively monitoring, analyzing, and/or categorizing tickets to enhance troubleshooting and overall product delivery.

It should be appreciated that the exemplary systems and methods are discussed in terms of monitoring, analyzing, and/or categorizing “tickets.” It should also be appreciated that as used herein, a “ticket,” “trouble ticket,” or “data/information associated to one or more tickets” may refer to any type of “issue.” It should be appreciated that as used herein, “issue” may refer to any “questions, problems, issues, and/or resolutions relating to a product and/or service” which may or may not be recorded in a ticket. For example, a ticket may be a repair request or other similar request identifying a particular issue. A ticket may also include data/information relating to how an issue is resolved. It should also be appreciated that as used herein, a “dispatch” may refer to any type of response (e.g., by a service provider or other entity) to resolve one or more issues (e.g., recorded in the ticket).

A “ticket,” as used herein, may also be referred to as “data/information associated with one or more tickets.” It should also be appreciated that a ticket may not necessarily be a physical ticket on paper. Rather, it may be any data/information that functions to track, document, and/or record an issue, as described herein.

It should also be appreciated that a ticket may be generated in a number of ways. For example, a ticket may be generated via telephone call (e.g., a subscriber calling a service provider and speaking with service provider representative), electronic submission (e.g., the subscriber transmitting a service requests via the service provider's website, email), or other similar action. In these examples, the service provider may provide a number of call centers and/or web agents to receive, interpret, and/or resolve the subscribers' questions or requests.

As discussed above, there may be a large number (e.g., approximately 500,000) of tickets related to television, data, and voice services on a monthly basis. However, manual response to these tickets to resolve, analyze, and/or categorize the root causes and/or patterns may be highly time consuming, not to mention large quantities of resources may also be expended. Additionally, by reading through many unrelated tickets covering a wide range of issues in varying fields, accurate results may not be readily attainable. Lack of uniformity and standardization may also contribute to imprecise analysis.

Furthermore, in competitive markets, identifying issues and/or trends of various products or services may be vital to business success. For example, understanding and monitoring problems that consumers face regarding a product or service may be used to provide improved solutions for a future product or service. While classical trend analysis may be useful, such an approach may be limited to a small and localized consumer base and for limited products that do not typically undergo transformations and/or upgrades. Consequently, for entities with products and/or services that have multiple product/service launches and/or releases, an adaptive approach may be more efficient.

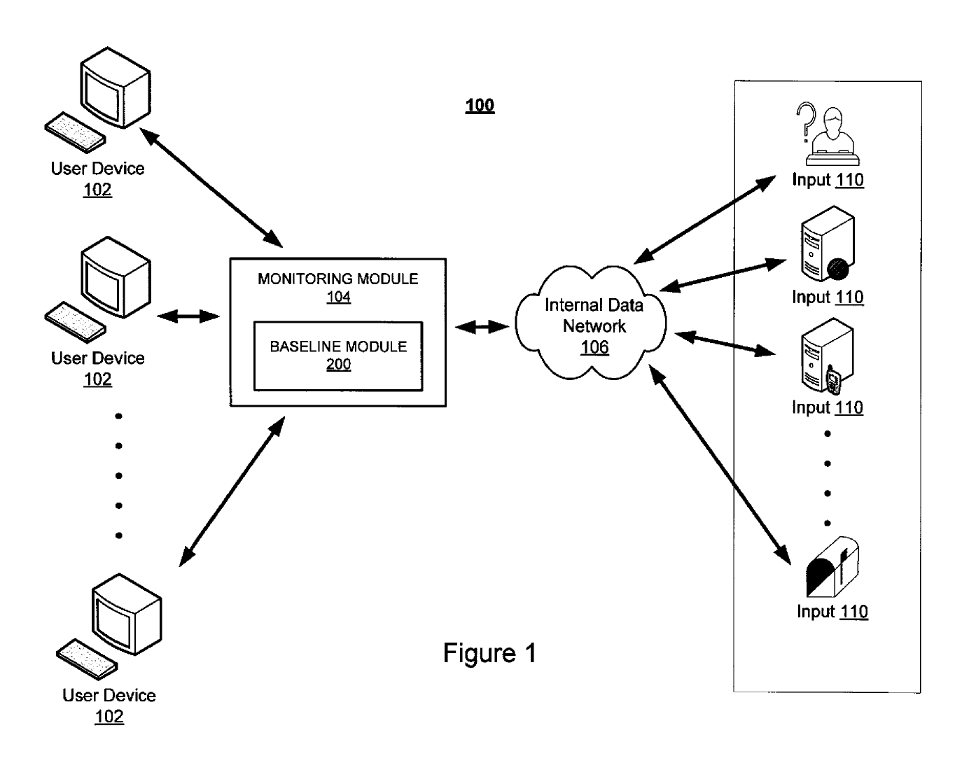

FIG. 1 depicts a block diagram of a system architecture 100 for comparative analysis of tickets and/or dispatches, according to an exemplary embodiment. The system 100 may monitor and/or analyze one or more tickets. In an exemplary embodiment, tickets may be submitted by customers, who are experiencing issues associated with a service (e.g., television services, Internet services, and/or telephone services) and/or equipment (e.g., wiring, set-up box, router, modem, television, and/or telephone) associated with a service. For example, the customers may experience issues associated with dropped wireless telephone calls, missing television channels, and/or lost of Internet connection. The customers may submit one or more tickets to a service provider to explain and/or resolve the issues. In an exemplary embodiment, the system 100 may include one or more inputs 110 (e.g., customer representatives, a telephone system, and/or an Internet server) that the users may use to submit the tickets. Also, the system 100 may include one or more user devices 102 which may interact with the one or more inputs 110 via a monitoring module 104 and/or an internal data network 106. The monitoring module 104 may include an baseline module/system 200 and/or other additional modules. The user may be associated with, but is not limited to, service providers, enterprises, educational institutions, government agencies, and any individual, group and/or organization running, maintaining and/or monitoring a network. Users within an organization may include, but are not limited to, network architects, network managers, engineers, planners, Network Operations Center (NOC) personnel, marketing, sales engineering, operations personnel, and customer support organizations. The user may monitor one or more parameters/keywords associated with the tickets submitted by user and generated by the one or more inputs 110. A relationship between various issues associated with the services and/or equipment and one or more parameters/keywords identified in the tickets may be established. For example, a power outage associated with the services and/or equipment may be related to thunderstorm and winds identified in the tickets. For example, the various parameters/keywords may include, but not limited to, a user name, account information, equipment, services, user's guides, geographical location, weather condition, troubleshooting, and/or other parameters a user may be interested to analyze/monitor. Also, one or more issues associated with services and/or equipment may include, but not limited to, issues associated with network elements and/or questions associated with television services features, Internet services features, telephone services features, installation, billing, and/or other issues a customer may experience.

The one or more user devices 102 may be a computer, a personal computer, a laptop, a cellular communication device, a global positioning system (GPS), a workstation, a mobile device, a phone, a handheld PC, a personal digital assistant (PDA), a thin system, a fat system, a network appliance, an Internet browser, a paging, an alert device, a television, an interactive television, a receiver, a tuner, a high definition (HD) television, a HD receiver, a video-on-demand (VOD) system, and/or other any other device that may allow a user to communicate with the monitoring module 104 via one or more networks (not shown) as known in the art.

A monitoring module 104 may be one or more servers. The monitoring module 104 may include a SQL Server, UNIX based servers, Windows 2000 Server, Microsoft IIS server, Apache HTTP server, API server, Java sever, Java Servlet API server, ASP server, PHP server, HTTP server, Mac OS X server, Oracle server, IP server, and/or other independent server to monitor and/or analyze the tickets generated by the one or more inputs 110. Also, the monitoring module 104 may store and/or run a variety of software, for example, Microsoft.NET framework.

The internal data network 106 may be coupled to the one or more inputs 110 via a management Ethernet port (not shown). The internal data network 106 may be a wireless network, a wired network or any combination of wireless network and wired network. For example, the internal data network 106 may include, without limitation, Internet network, satellite network (e.g., operating in Band C, Band Ku and/or Band Ka), wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or any other wireless network for transmitting a signal. In addition, the internal data network 106 may include, without limitation, telephone line, fiber optics, IEEE Ethernet 802.3, wide area network (WAN), local area network (LAN), global network such as the Internet. Also, the internal data network 106 may enable, an Internet network, a wireless communication network, a cellular network, an Intranet, or the like, or any combination thereof. The internal data network 106 may further include one, or any number of the exemplary types of networks mentioned above operating as a stand-alone network or in cooperation with each other.

A user associated with the one or more user devices 102 may interactively browse, monitor, and/or analyze tickets generated by the one or more inputs 110 to display various information associated with the tickets via the one or more user devices 102. For example, the one or more inputs 110 may include, but is not limited to, a customer representative, an automated telephonic service, an Internet website/webpage, a mail postal service, and/or other methods of communicating issues associated with services and/or equipment. Also, the one or more inputs 110 may include telephone systems and/or Internet servers. In an exemplary embodiment, the one or more inputs 110 may be a customer representative (e.g., a live person) and a customer may contact the customer representative via a telephone, a computer and/or in person. The customer representative may generate one or more tickets for the customer that is experiencing issues associated with services and/or equipment. In another exemplary embodiment, the one or more inputs 110 may be an automated telephone service, where a customer may dial into a telephone system to report issues associated with services and/or equipment. The telephone system may prompt the customer for response to one or more questions and generate one or more tickets based on the customer's response. In other exemplary embodiments, the one or more inputs 110 may be an Internet website/webpage hosted by an Internet server. For example, customers may access the website/webpage and report issues associated with services and/or equipment. In an additional exemplary embodiment, the one or more inputs 110 may be a mail postal service, where a customer may mail a letter and/or a ticket to a service provider to report issues associated with service and/or equipment. Also, the one or more inputs 110 may be located at various geographical locations (e.g., various cities, zip codes, states, and/or countries) for servicing users located at the various geographical locations. Further, one or more inputs 110 may be include one or more user input interface in order to allow the users to enter information associated with the issues of the services and/or the equipment.

In one embodiment, a “baseline” approach may enable effective monitoring and/or analysis of tickets or dispatches to solve one or more associated issues. These “baselines” may be designed and created to provide a trending of tickets/dispatches based on various factors, such as a particular release, geographic location, etc. In addition, such trending or patterning may also include various products, service areas, time ranges, and/or other similar trending factors. Accordingly, a comparative analysis of ticket/dispatch volumes (e.g., represented by “baselines”) may be used to compare one product/service to another, one release/upgrade to another, one geographic location to another, overall evolution of a product/service, and/or other similar comparisons. As a result, by monitoring and/or analyzing tickets/dispatches using this baseline approach, expanded and more comprehensive business strategies may be implemented to accommodate the fast pace and rapid changes in current markets and/or businesses.

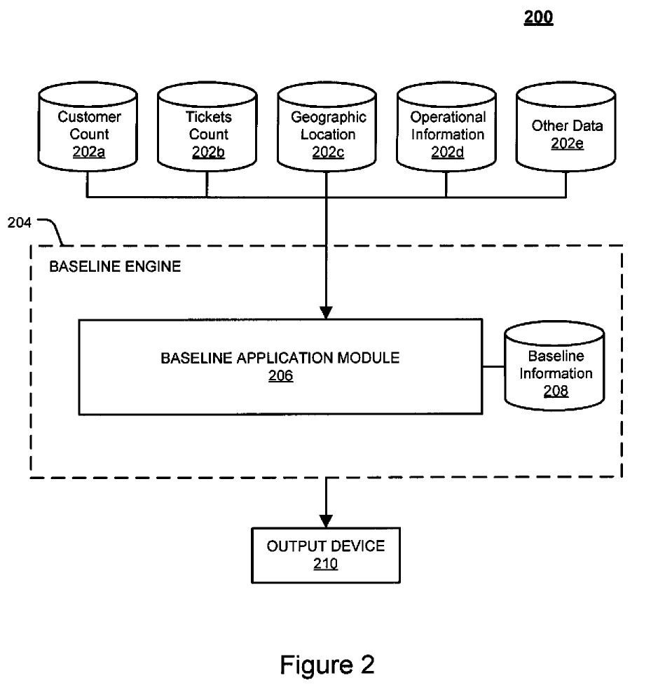

FIG. 2 depicts a block diagram of a baseline module/system architecture 200 for comparative analysis of tickets and/or dispatches, according to an exemplary embodiment. It should be appreciated that system 200 is a simplified view for analyzing tickets and may include additional elements that are not depicted. As illustrated, the system 200 may include one or more data storage units. For example, the one or more data storage units may store a variety of data/information, such as customer count 202a, ticket count 202b, geographic location 202c, operational information 202d, and other data 202e. The one or more data storage units may provide one or more tickets/dispatches for analysis. In some embodiments, the one or more data storage units may store and/or provide information via manual feed, automatic feed, other alternative types of feed, or a combination thereof. The one or more data storage units may be communicatively coupled to a baseline engine 204 for processing the data/information received from the one or more data storage units. In one embodiment, the baseline engine 204 may have at least one of a receiver, processor, and transmitter. In another embodiment, the baseline engine 204 may include a baseline application module 206 communicatively coupled to a database storing baseline information 208. It should be appreciated that in some embodiments, the one or more data storage units and/or the baseline engine 204 may translate/convert/reformat the data for compatibility. The one or more tickets/dispatches may be analyzed by the baseline engine 204 at the baseline application module 206. Once the one or more tickets/dispatches from the one or more data storage units 202 are analyzed by the baseline application module 206, the processed data associated with the one or more analyzed tickets/dispatches may be transmitted to an output 210. In some embodiments, the output 210 may display ticket/dispatch count. Other various embodiments may also be provided.

The data storage unit for customer count 202a may receive and store information associated with customers, e.g., number of total customers. This information may be received from one or more provision systems or other systems that keep track of customer information, such as number of current and new customers. The data storage unit for ticket count 202b may receive and store information associated with tickets, e.g., number of tickets received. This information may be received from one or more agents, representatives, and/or other ticket-receiving systems. The data storage unit for geographic location 202c may receive and store information associated with geography, e.g., where servers are located, where agents receive tickets, where agents generate dispatches, where tickets/dispatches are resolved, etc. This information may be received from one or more servers having software and/or hardware configured to identify geographic information. This information may also be received from agents, representatives, and/or systems for handling tickets/dispatches (e.g., support centers). Other various embodiments may also be provided. The data storage unit for operational information 202d may receive and store information associated with third parties, e.g., information from third-party providers, such as a television network/channel. For example, in a video service provider embodiment, the data storage unit for operational information 202d may receive information from televisions network/channel/station (e.g., ESPN, CNN, etc.) regarding issues it may be having. Accordingly, this information may be received and stored in the data storage unit for operational information 202d. Other data 202e may also be received and stored at the one or more data storage units 202.

It should be appreciated that the baseline information may also be part of the one or more data storage units 202. It should also be appreciated that the one or more data storage units 202 may be modules having a variety of configurations to store more or less data/information.

The one or more data storage units 202 may store a variety of tickets and/or dispatches in a variety of ways and/or formats. For example, as described above, tickets may be generated by a service provider agent, via the web, and/or other ticket generation methodologies (e.g., electronically, automatically, etc.) and may be stored at the one or more data storage units 202 before transmission to the baseline engine 204 for analysis/processing.

The baseline engine 204 may include one or more servers, server-like systems, and/or modules configured to analyze tickets. As discussed above, the baseline engine 204 may include a baseline application module 206 communicatively coupled to a baseline information database 208 to process information received from the one or more data storage units 202. In some embodiments, by parsing text/fields of each ticket/dispatch, which may include approximately 50-70 fields per ticket/dispatch, the baseline application module 206 may qualitatively determine what text/fields are relevant/irrelevant and weigh these text/fields appropriately for more efficient and accurate comparative analysis.

It should be appreciated that the baseline engine 204 may process/analyze tickets and/or dispatches based on several factors. For example, the baseline engine 204 may calculate baseline information for a particular release for a particular time period for a customer. Here, a ratio between the number of total customers and a number of tickets associated with the particular release may be generated at regular time intervals (e.g., daily) or irregular time intervals (e.g., on demand). This ratio may indicate a quantitative comparison as to how that particular release is doing for that particular time period. In addition, the baseline engine 204 may calculate baseline information along with tickets/dispatches associated with other information, such as geographic location, data center location, operational product outages, etc. Such analysis may also be used provide information a ratio (e.g., a rate factor). For example, the rate factor may be used to determine a call rate for a specific day of the week. In some embodiments, this rate factor may be multiplied by the current user base on a daily basis to determine a baseline for a particular product or service for a specific release for a specific day of the week. Accordingly, processing logic of the baseline application module 206 of the baseline engine 204 may generate baseline information on a daily basis for products, geographic locations, regions for a number of releases and/or modules. Other various embodiments may also be provided.

It should be appreciated that qualitative and quantitative baseline analysis may be provided independently, interdependently, or a combination thereof. It should also be appreciated that a variety of additional information may be used to generate baseline information for comparative analysis and/or trending.

The output 210 may receive the generated baseline information from the baseline engine 204. In some embodiments, the output 210 may display the baseline information to users along with ticket/dispatch count. Other various embodiments may also be provided.

By generating and displaying baseline information for tickets and/or dispatches, trends and/or patterns associated with one or more products or services may be more easily identified. For example, in the event a majority of the tickets received/resolved by a service provider are directed to a power issue of a particular set top box, the service provider may be able to identify this problem and resolve it in a variety of ways. These may include, for example, recalling that particular set top box, issue a general fix for all those who use that particular set top box, provide an upgraded set top box that does not have that same problem, make note of the problem as in developing the new version of that set top box. Generating and displaying a baseline for the product may provide perspective on whether the set top box is doing well on one day versus another or when compared to previous versions. Other various comparisons, such as comparing different products/services, releases, regions, etc., may also be made to allow the user (e.g., the service provider) to track whether attempts to fix the problem and/or modifications to the set top box are effective. In some embodiments, training and/or coaching sessions may be created based on the particular issues represented by the baseline information. Other various embodiments may also be provided.

For example, after tickets are analyzed/processed by the baseline engine 204, the processed data 116 may be transmitted to the output 118 (e.g., a display device). Here, the data/information associated with the tickets may be used to improve product support and delivery. For instance, the analysis of tickets may indicate that the release of a particular version of television service by the service provider had several issues with connectivity with a certain television or a poor connection in certain geographic areas, etc. The service provider of the television service may then use this information at the output 118 to universally repair this particular television service feature and/or implement upgrades, patches, and/or other improvements in future releases/versions. Other various embodiments may also be provided.

It should be appreciated that each of the components of the system 200 may be configured to receive, transmit, and/or process signals/data. For example, each of servers, server-like systems, and/or modules of the baseline application module 206 may have one or more receivers, one or more transmitters, and/or one or more processors in order to communicate (e.g., receive, process, and/or transmit data/information) with the other components of system 200. Communications may be achieved via transmission of electric, electromagnetic, optical, or wireless signals and/or packets that carry digital data streams using a standard telecommunications protocol and/or a standard networking protocol. These may include Session Initiation Protocol (SIP), Voice Over IP (VoIP) protocols, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols. Other protocols and/or systems that are suitable for transmitting and/or receiving data via packets/signals may also be provided. For example, cabled network or telecom connections such as an Ethernet RJ45/Category 5 Ethernet connection, a fiber connection, a traditional phone wireline connection, a cable connection or other wired network connection may also be used. Communication between the network providers and/or subscribers may also use standard wireless protocols including IEEE 802.11a, 802.11b, 802.11g, etc., or via protocols for a wired connection, such as an IEEE Ethernet 802.3.

It should be appreciated that communications between components of system 200 may be conducted over a network (not shown), such as a local area network (LAN), a wide area network (WAN), a service provider network, the Internet, or other similar network. It should be appreciated that the network may use electric, electromagnetic, and/or optical signals that carry digital data streams.

It should also be appreciated that the components of system 200 may be used independently or may be used as an integrated component in another device and/or system. It should also be appreciated that the devices, modules, and/or components of system 200 are shown as separate components, these may be combined into greater or lesser components to optimize flexibility. The devices, modules, and/or components of system 200 may also be local, remote, or a combination thereof to each other or other system components. Other various embodiments may also be realized.

While depicted as components, servers, modules, platforms, and/or devices of the system 200, it should be appreciated that embodiments may be constructed in software and/or hardware, as separate and/or stand-alone, or as part of an integrated transmission and/or switching device/networks. For example, it should also be appreciated that the one or more network components, servers, modules, platforms, and/or devices of the system 200 may not be limited to physical components. These components may be software-based, virtual, etc. Moreover, the various components, servers, modules, and/or devices may be customized to perform one or more additional features and functionalities. Also, although depicted as singular network or system components, each of the various networks or system components may be equal, greater, or lesser.

Additionally, it should also be appreciated that support and updating of the various components of the system 200 may be easily achieved. For example, an administrator may have access to one or more of these networks or system components. Such features and functionalities may be provided via deployment, transmitting and/or installing software/hardware.

It should also be appreciated that each of the system components may include one or more processors, servers, modules, and/or devices for optimizing comparative analysis of tickets and/or dispatches. It should be appreciated that one or more data storage systems (e.g., databases) (not shown) may also be coupled to each of the one or more processors, servers, modules, and/or devices of the system 200 to store relevant information for each of the servers and system components. Other various embodiments may also be provided. The contents of any of these one or more data storage systems may be combined into fewer or greater number of data storage systems and may be stored on one or more data storage systems and/or servers. Furthermore, the data storage systems may be local, remote, or a combination thereof to clients systems, servers, and/or other system components. In another embodiment, information stored in the databases may be useful in providing additional customizations/implementations for optimizing comparative analysis of tickets and/or dispatches. Other various embodiments and variations may also be realized.

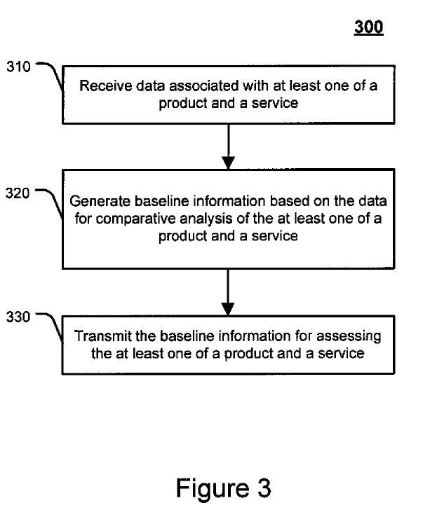

FIG. 3 depicts a flowchart of a method for analyzing tickets, according to an exemplary embodiment. The exemplary method 300 is provided by way of example, as there are a variety of ways to carry out methods disclosed herein. The method 300 shown in FIG. 3 may be executed or otherwise performed by one or a combination of various systems. The method 300 is described below as carried out by at least system 200 in FIG. 2, by way of example, and various elements of systems 200 are referenced in explaining the example method of FIG. 3. Each block shown in FIG. 3 represents one or more processes, methods, or subroutines carried in the exemplary method 300. A computer readable media comprising code to perform the acts of the method 300 may also be provided. Referring to FIG. 3, the exemplary method 300 may begin at block 310.

At block 310, data associated with at least one of a product and a service may be received. For example, a receiver at the baseline engine 204, or more specifically at the baseline application module 206, may receive data associated with at least one of a product and a service for comparative analysis. In some embodiments, the data may be received from one or more data storage units 202, which may receive the data from customers, users, other data storage systems, etc. In other embodiments, the data received by the baseline engine 204 may include at least one of customer-related information (e.g., customer count), ticket- or dispatch-related information (e.g., ticket or dispatch count), geographic location, and operational information.

At block 320, the data may be analyzed. For example, a processor at the baseline engine 204, or more specifically the baseline application module 206, may analyze the data by at least generating baseline information based on the data. In some embodiments, by parsing text/fields of each ticket/dispatch, which may include approximately 50-70 fields per ticket/dispatch, the baseline application module 206 may qualitatively determine what text/fields are relevant/irrelevant and weigh these text/fields appropriately for more efficient and accurate comparative analysis. In other embodiments, the baseline engine 204 may quantitatively calculate baseline information for a particular release for a particular time period for a customer. For example, a ratio between the number of total customers and a number of tickets associated with the particular release may be generated at regular time intervals (e.g., daily). This ratio may indicate a quantitative comparison as to how that particular release is doing for that particular time period. In addition, the baseline engine 204 may calculate baseline information along with tickets/dispatches associated with other information, such as geographic location, data center location, operational product outages, etc. Such analysis may also be used provide information a ratio (e.g., a rate factor), which in turn may be used to determine a call rate for a specific day of the week. In some embodiments, this rate factor may be multiplied by the current user base on a daily basis to determine a baseline for a particular product or service for a specific release for a specific day of the week. In some embodiments, the baseline information may represent a comparative analysis of the at least one of a product and a service. In some embodiments, the baseline information may be generated at regular time intervals (e.g., weekly, daily, hourly, etc.) or irregular time intervals (e.g., on demand). In other embodiments, the baseline information may be generated for the at least one of a product and service for a release for a particular date (e.g., a specific day). Accordingly, processing logic of the baseline application module 206 of the baseline engine 204 may generate baseline information on a daily basis for products, geographic locations, regions for a number of releases and/or modules.

It should be appreciated that the baseline information may also be stored at one or more baseline information storage systems. It should also be appreciated that the comparative analysis may include comparing at least one of products, services, versions, releases, upgrades, modifications, geographic locations, regions, predetermined populations, customer base, and ticket or dispatch count. Other various embodiments may also be realized.

At block 330, baseline information may be outputted. For example, a transmitter at the baseline engine 204 may transmit the baseline information to the output device 210 (e.g., a display device) for assessing the at least one of a product and a service. The baseline information may be outputted from at least one of the baseline application module 206 and the one or more baseline information storage systems (e.g., the baseline information database 208). For example, in some embodiments, outputting the baseline information may include displaying the baseline information (e.g., at a display device) to one or more users (e.g., via a portal). In other embodiments, the baseline information may be displayed along with at least a ticket or dispatch count. Other various embodiments may also be provided.

It should be appreciated that although embodiments are described primarily with comparative analysis of tickets and/or dispatches, the systems and methods discussed above are provided as merely exemplary and may have other applications. These may include any application/analysis related to enterprise level product or services where trending and/or patterning may be useful. Embodiments may also be beneficial for training, coaching, updating, fieldwork, and/or other similar area.

It should be appreciated that one or more databases (not shown) may be communicatively coupled to the components of system 200 to store data/information associated with the one or more tickets, dispatches, and/or baselines.

Although embodiments are directed to comparative analysis of tickets and/or dispatches in services relating to television, data, and/or voice, it should be appreciated that analysis outside of these ticketed services may also be provided. These may include secure communications, comprehensive network maintenance/support, hardware/software delivery, e-commerce, financial/banking services, entertainment, marketing, and advertisement related services, etc.

It should also be appreciated that exemplary embodiments may be extended to other various enterprise level products and/or services where comparative analysis or similar trending/patterning may be beneficial. For example, the system 200 may have other applications and/or implementations, such as in providing training, coaching, or quick updates to call center agents/representatives, field technicians, etc. Thus, any business entity interested in improving product/service usage may implement exemplary embodiments for comparative analysis.

It should also be appreciated that exemplary embodiments may support one or more additional security and/or business functions/features. For example, while comparative analysis of tickets and/or dispatches is described as being implemented at the baseline application module 206, embodiments may be implemented at one, all, or a combination of at least the other components depicted in system 200.

It should be appreciated that while exemplary embodiments are described as being implemented over wired networks and systems, other various embodiments may also be provided. For example, registration may be implemented over wireless networks or systems. Whether wired or wireless, the network and/or system may be a local area network (LAN), wide area network (WAN), or any other network configuration. Additionally, various communication interfaces may be used. These may include an integrated services digital network (ISDN) card or a modem to provide a data communication connection. In another embodiment, the communication interface may be a local area network (LAN) card to provide a data communication connection to a compatible LAN. Wireless links (e.g., microwave, radio, etc.) may also be implemented. In any such implementation, the communication interface may send and receive electrical, electromagnetic, and/or optical signals that carry digital data streams representing various types of information.

In one embodiment, the wireline network/system may include long-range optical data communications, local area network based protocols, wide area networks, and/or other similar applications. In another embodiment, wireless broadband connection may include long-range wireless radio, local area wireless network such as Wi-Fi (802.11xx) based protocols, wireless wide area network such as Code Division Multiple Access (CDMA)—Evolution Data Only/Optimized (EVDO), Global System for Mobile-Communications (GSM)—High Speed Packet Access (HSPA), WiMax, infrared, voice command, Bluetooth™, Long Term Evolution (LTE), and/or other similar applications. In yet another embodiment, the network with which communications are made may include the Internet or World Wide Web. Other networks may also be utilized for connecting each of the various devices, systems and/or servers.

By performing the various features and functions as discussed above, the systems and methods described may allow comprehensive and efficient analysis of tickets/disptaches and other similar enterprise product enhancement and/or servicing.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method, comprising:
receiving, by a baseline engine, data associated with at least one of a product and a service corresponding to one or more tickets or dispatches;
generating baseline information by the baseline engine based on the data, wherein the baseline information represents a comparative analysis of the at least one of a product and a service; and
transmitting, from the baseline engine to an output device, the baseline information for assessing the at least one product and service.

2. The method of claim 1, further comprising storing the baseline information in one or more baseline information storage systems.

3. The method of claim 1, wherein data is received from one or more data storage systems.

4. The method of claim 1, wherein data comprises at least one of customer count, ticket or dispatch count, geographic location, and operational information.

5. The method of claim 1, wherein baseline information is generated daily.

6. The method of claim 1, wherein baseline information is generated for the at least one of a product and service for a release for a specific day.

7. The method of claim 1, wherein the comparative analysis comprises comparing at least one of products, services, versions, releases, upgrades, modifications, geographic locations, regions, predetermined populations, customer base, and ticket or dispatch count.

8. The method of claim 1, wherein outputting the baseline information comprises displaying, at a display device, the baseline information to one or more users.

9. The method of claim 8, wherein the baseline information is displayed along with at least one ticket or dispatch count.

10. A computer readable medium comprising code to perform the acts of the method of claim 1.

11. A system, comprising:
a receiver, at a baseline engine, configured to receive data associated with at least one of a product and a service corresponding to one or more tickets or dispatches;
a processor, at the baseline engine, configured to generate baseline information based on the data, wherein the baseline information represents a comparative analysis of the at least one of a product and a service; and
a transmitter, at the baseline engine, configured to output the baseline information to an output device for assessing the at least one product and service.

12. The system of claim 11, further comprising one or more baseline information storage systems to store the baseline information.

13. The system of claim 11, further comprising one or more data storage systems for storing the data.

14. The system of claim 11, wherein data comprises at least one of customer count, ticket or dispatch count, geographic location, and operational information.

15. The system of claim 11, wherein the processor generates baseline information based on the data on a daily basis.

16. The system of claim 11, wherein the processor generates baseline information for the at least one of a product and service for a release for a specific day.

17. The system of claim 11, wherein the comparative analysis provides trending comparisons of at least one of products, services, versions, releases, upgrades, modifications, geographic locations, regions, predetermined populations, customer base, and ticket or dispatch count.

18. The system of claim 11, wherein the output device is a display device for displaying the baseline information to one or more users.

19. The system of claim 18, wherein the baseline information is displayed along with at least one ticket or dispatch count.
